(19) United States
(12) Patent Application Publication
(10) Pub. No.: US 2019/0051971 A1
(43) Pub. Date: Feb. 14, 2019

(54) MOBILE DEVICE AND ANTENNA THEREFOR

(71) Applicant: Acer Incorporated, New Taipei City (TW)

(72) Inventors: Cheng-Yu Hsieh, New Taipei City (TW); Kun-Sheng Chang, New Taipei City (TW); Ching-Chi Lin, New Taipei City (TW)

(21) Appl. No.: 15/832,825

(22) Filed: Dec. 6, 2017

(30) Foreign Application Priority Data
Aug. 9, 2017 (TW) 106126826

(51) Int. Cl. H01Q 1/22; H01Q 21/30; H04B 1/3827; H01Q 1/24; H01Q 9/42; H01Q 9/04

(52) U.S. Cl. CPC H01Q 1/2266; H01Q 21/30; H04B 1/3838; H01Q 5/357; H01Q 9/42; H01Q 9/0421; H01Q 1/243

(57) ABSTRACT

A mobile device includes a housing including a metal case and an antenna mounted inside the housing. The antenna includes a first radiation portion disposed on a first surface of a substrate, a second radiation portion disposed on an opposing surface of the substrate, and a ground element, wherein the second radiation portion includes a first grounding point and a second grounding point that are each electrically connected to the metal case via the ground element.

This application claims the benefit of Taiwan Application Serial No. 106126826, filed Aug. 9, 2017, the subject matter of which is incorporated herein by reference.

### TECHNICAL FIELD

Embodiments of the present invention are directed to a mobile device and a dual frequency band antenna therefor.

### BACKGROUND

In recent years, design elements of mobile communication devices have become increasingly important. One feature that has become particularly popular is that of a metal cover. Such metal covers, however, can influence the radio frequency (RF) characteristics of an internal antenna of the mobile communication device.

Antennas of such mobile devices are often configured to operate over at least two frequency bands, making tuning of such a dual- or multi-band antenna challenging, especially in the presence of a metal cover.

### SUMMARY

In one embodiment, a mobile electronic device, such as a laptop computer, is provided and includes a housing including a metal case and an antenna mounted inside the housing. The antenna comprises: a first radiation portion disposed on a first surface of a substrate, a second radiation portion disposed on an opposing surface of the substrate, and a ground element, wherein the second radiation portion includes a first grounding point and a second grounding point that are each electrically connected to the metal case via the ground element.

In an embodiment, an insulating element may be disposed between the substrate and the metal case. Further, the first surface of the substrate may be configured to face the insulating element.

A conductive through hole passes through the substrate and electrically connects the first radiation portion and the second radiation portion. The first radiation portion mat be a metal trace, and the conductive through hole is disposed at a first end of the metal trace and a feedpoint for the antenna is disposed at a second end of the metal trace.

The first radiation portion may comprise a single segment and the second radiation portion may comprise a plurality of segments, the single segment of the first radiation portion may overlap with at least one segment of the plurality of segments of the second radiation portion.

The first radiation portion may comprise an L-shaped trace having a first shorter segment and a second longer segment, and the second radiation portion may comprise a plurality of segments, and a coupling gap may be defined between the second longer segment of the L-shaped trace and at least one segment of the plurality of segments of the second radiation portion, wherein the coupling gap extends in a direction perpendicular to a thickness direction of the substrate.

In the disclosed configuration, a first resonant path extends between a feed point at one end of the first radiation portion and the first grounding point, and a second resonant path extends between the feed point at one end of the radiation portion and the second grounding point. The first resonant path is configured to resonate at a first frequency band, and the second resonant path is configured to resonate at a second frequency band. The first frequency band may be centered at about 2.4 GHz and the second frequency band may be centered at about 5 GHz.

### BRIEF DESCRIPTION OF THE DRAWINGS

Embodiments are described herein in conjunction with the accompanying drawings, in which:

FIG. 1A is a schematic view illustrating elements of an antenna and a part of an electronic device according to an embodiment of the present invention;

FIG. 1B is a schematic view illustrating a first radiation portion of the antenna according to an embodiment of the present invention;

FIG. 1C is a schematic view illustrating the electronic device of FIG. 1A including the first radiation portion according to an embodiment of the present invention;

FIG. 2 is a schematic view illustrating another embodiment of the antenna and a part of the electronic device according to the present invention;

FIG. 3 is a schematic view illustrating still another embodiment of the antenna and a part of the electronic device according to the present invention;

FIG. 4 is a graph depicting the frequency response of the embodiment of FIG. 3 according to the present invention;

FIG. 5 are smith charts depicting the performance of the embodiment of FIG. 3 according to the present invention; and

FIG. 6 is a perspective view of the electronic device according to an embodiment of the present invention.

FIG. 7 is a schematic view illustrating a sectional view of the embodiment of FIG. 1A according to an embodiment of the present invention.

### DESCRIPTION OF EXAMPLE EMBODIMENTS

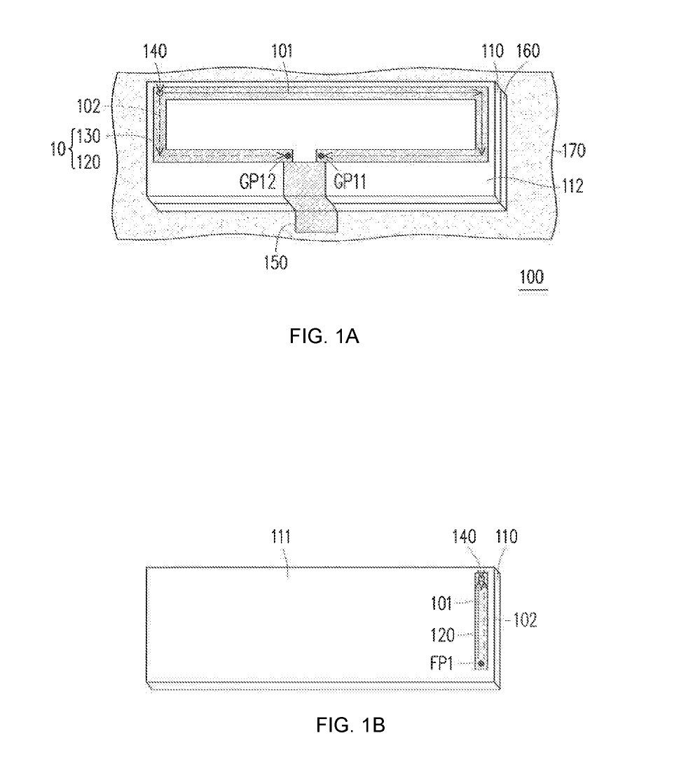

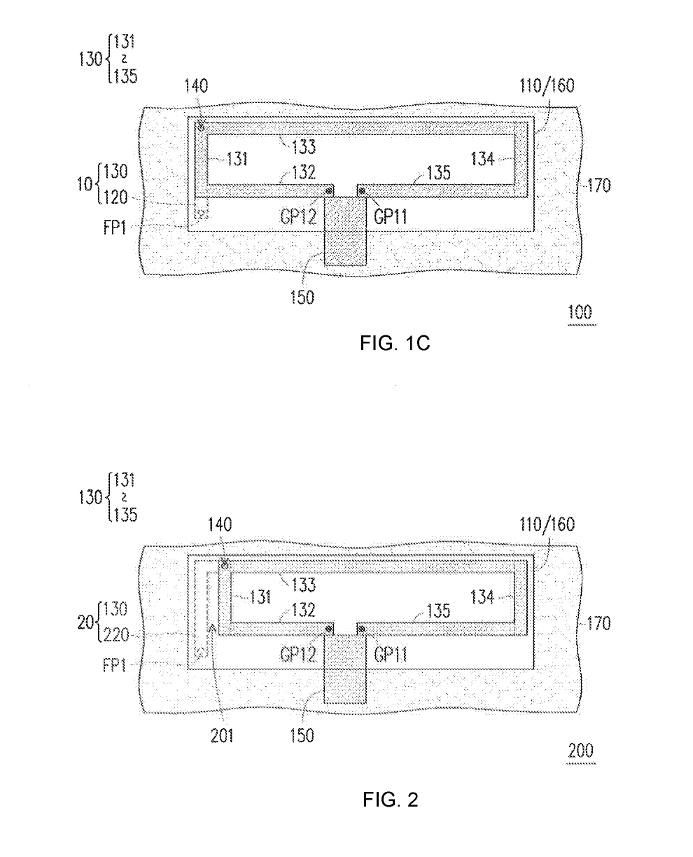

FIG. 1A is a schematic view illustrating elements of an antenna and a part of an electronic device according to an embodiment of the present invention. FIG. 1B is a schematic view illustrating a first radiation portion of the antenna according to an embodiment of the present invention. As shown in FIG. 1A and FIG. 1B, an electronic device 100 includes a substrate 110, a first surface 111, a second surface 112, a first radiation portion 120, a second radiation portion 130 and a conductive through hole 140.

As shown in FIG. 1B, the first radiation portion 120 is disposed on the first surface 111 of the substrate 110 and the first radiation portion 120 has a feed point FP1. As shown in FIG. 1A, the second radiation portion 130 is disposed on the second surface 112 of the substrate 110 and the second radiation portion 130 has a first grounding point GP11 and a second grounding point GP12. The conductive through hole 140 penetrates the first radiation portion 120, the substrate 110 and the second radiation portion 130. The conductive through hole 140 electrically connects the first radiation portion 120 and the second radiation portion 130.

The first radiation portion 120 and the second radiation 130 form an antenna 10. The antenna 10 receives a feed signal generated by a transceiver (not shown) in the electronic device 100 via feed point FP1. For example, the antenna 10 can be electrically connected to the transceiver via a coaxial cable (not shown). An inner conductor of such a coaxial cable may be electrically connected to the feed point FP1. An outer conductor of such a coaxial cable may be connected to the first grounding point GP11 and the second grounding point GP12 and an associated ground element 150 that is connected to a ground plane (not shown) of the electronic device 100.

The antenna 10 is formed by a first resonant path 101 and a second resonant path 102. The first resonant path 101 is formed between the feed point FP1 and the first grounding point GP11 and the second resonant path 102 is formed between the feed point FP1 and the second grounding point GP12. With excitation using the feed signal, the antenna 10 can operate in a first frequency band (e.g., 2.4 GHz) via the first resonant path 101 and can operate in a second frequency band (e.g., 5 GHz) via the second resonant path 102. Notably, impedance matching for the first frequency band can be adjusted via the second resonant path 102. Accordingly, the metallic environment (i.e., a proximate metal cover) impact on antenna 10 can be reduced thereby helping to improve the performance of the antenna 10 and wireless communication quality of the electronic device 100.

In addition to the ground element 150, an embodiment of the electronic device 100 further includes an insulating (e.g., plastic) element 160 and metal case 170. The insulating element 160 is disposed between the substrate 110 and metal case 170 and faces the first surface 111 of substrate 110. The insulating element 160 overlays on metal case 170 and the substrate 110 overlays on the plastic element 160. In other words, the antenna 10 on substrate 110 is positioned on the metal case 170 via the plastic element 160. The first grounding point GP11 and second grounding point GP12 of antenna 10 are electrically connected to metal case 170 via the ground element 150. The metal case 170 is connected to a system ground plane of electric device 100.

In operation, the second resonant path 102 of antenna 10 can produce an inductance effect. For example, the second resonant path 102 of antenna 10 (the first radiation element 120 and a portion of second element 130) can form an equivalent inductor to increase the inductance of antenna 10 in the first band. The capacitance between antenna element 10 and metal case 170 can be balanced via such an inductance.

In other words, the impedance matching of antenna 10 in the first band can be adjusted via the second path 102. This is helpful to improve the radiation efficiency of antenna 10. Antenna 10 can thus be more easily incorporated into electronic device 100 even when electronic device 100 is configured with a full slim metal case. In addition, the first grounding point GP11 and the second grounding point GP12 are configured to be on the same side of substrate 110. Consequently, the first grounding point GP11 and the second grounding point GP12 can be electrically connected to metal case 170 via the ground element 150 and thus make assembly of the antenna and electronic device more simple.

FIG. 1C is a schematic view illustrating the electronic device 100 of FIG. 1A including the first radiation portion 120 according to an embodiment of the present invention. As shown in FIG. 1C, the second radiation portion 130 includes a first segment 131 to a 5^{th} segment 135. A first end of first segment 131 is electrically connected to a first end of the first radiation portion 120 via the conductive through hole 140. A second end of the first radiation portion includes feed point FP1. A first end of the second segment 132 is electrically connected to a second end of the first segment 131. Ground point GP2 is disposed at a second end of the second segment 132. In accordance with an embodiment, the first radiation portion 120, the first segment 131 and second segment 132 can form the second path 102, as shown in FIG. 1A.

The third segment to the 5^{th} segment 133˜135 are electrically connected to each other. The third segment 133 is electrically connected to the first end of the first segment 131. Ground point GP11 is disposed at an end of the 5^{th} segment 135. In accordance with an embodiment, the first radiation portion 120, the first end of the first segment 131 and the segments 133˜135 can form the first path 101, as shown in FIG. 1A. As further shown in FIG. 1C, the third segment 133, the second segment 132 and the 5^{th} segment 135 are positioned between the locations of the first segment 131 and the 4^{th} segment 134. The third segment 133 faces the second segment 132 and the 5^{th} segment 135.

In an embodiment, there is a coupling gap between the first radiation portion 120 and the first segment 131 to help miniaturize the size of antenna 10. For example, the first radiation portion 120 can be a metal straight line or trace. The projection area of the first segment 131 on the substrate 110 can partially overlap or completely overlap with the projection area of the first radiation portion 120 on substrate 110. The thickness of the substrate 110 can function as a coupling gap between the first segment 131 and the first radiation portion 120. Further, the antenna 10 can be a loop antenna and a resonance path of the antenna 10 may be shorter than a half wavelength of a desired band because of the coupling effect between the first radiation portion 120 and the first segment 131. For example, the length of the first path 101 is between one half wavelength and one-third wavelength of the first operation frequency band and the length of the second path 102 is between one-third wavelength and one-fourth wavelength of the second operation frequency band.

FIG. 2 is a schematic view illustrating another embodiment of an antenna and a part of the electronic device according to the present invention. Compared with the embodiment shown in FIG. 1A, antenna 20 of the electrical device 200 in the FIG. 2 includes the first radiation portion 220 which comprises an inverted-L shape metal line or trace. With such a configuration, there is a coupling gap 201 between the projection of the first segment 131 on substrate 110 and the projection of the first radiation portion 220 on substrate 110. A further coupling effect is generated between the first radiation portion 220 and the first segment 131 via the coupling gap 201 such that the size of antenna 20 can be miniaturized.

As in the embodiment of FIG. 1A, the first radiation portion 220, the first end of the segment 131 and the segments 133˜135 can form the first radiation path and the first radiation portion 220, the first segment 131 and the second segment 132 can form the second radiation path. The antenna 20 can operate in the first frequency band via the first resonance path and operate in the second frequency band via the second radiation band. In addition, the impedance matching of the antenna 20 can be adjusted via the second resonance path. For example the first radiation portion 220, the first segment 131 and the second segment 132 can increase the inductance of the antenna 20 to balance the capacitance effect caused by the metal case 170. The radiation efficiency of the antenna element will thus increase and the wireless communication quality of the electric device 200 can be improved.

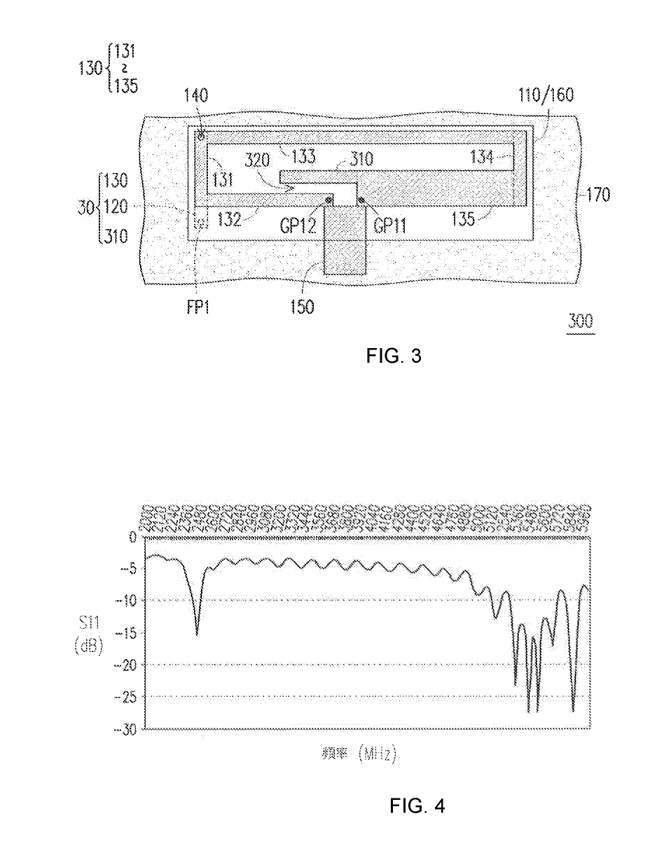

FIG. 3 is a schematic view illustrating still another embodiment of the antenna and a part of the electronic device according to the present invention. Compared with the embodiment shown in FIG. 1A, the antenna 30 of electric device 300 in FIG. 3 includes extension element 310. In this embodiment, the width of the 5^{th} segment 135 is wider than the segments 131˜134. Generally speaking, the extension element 310 is electrically connected to the 5^{th} segment 135 and spaced from the second segment 132 by gap 320. The antenna 30 can operate in the first frequency band via the resonance path from the feed point FP1 to the first ground point GP11 and operate in the second frequency band via the second resonance path from the feed point FP1 to the second ground point GP12. In addition the impedance matching for the first frequency band can be adjusted via the second resonant path such that the radiation efficiency of the antenna 30 can be improved. In an embodiment, the length of the extension element 310 is shorter than a quarter wavelength of the second operation frequency. Further, the impedance matching for the first frequency band and the second frequency band can be adjusted via the extension element 310 such that the radiation efficiency of the antenna 30 can be improved.

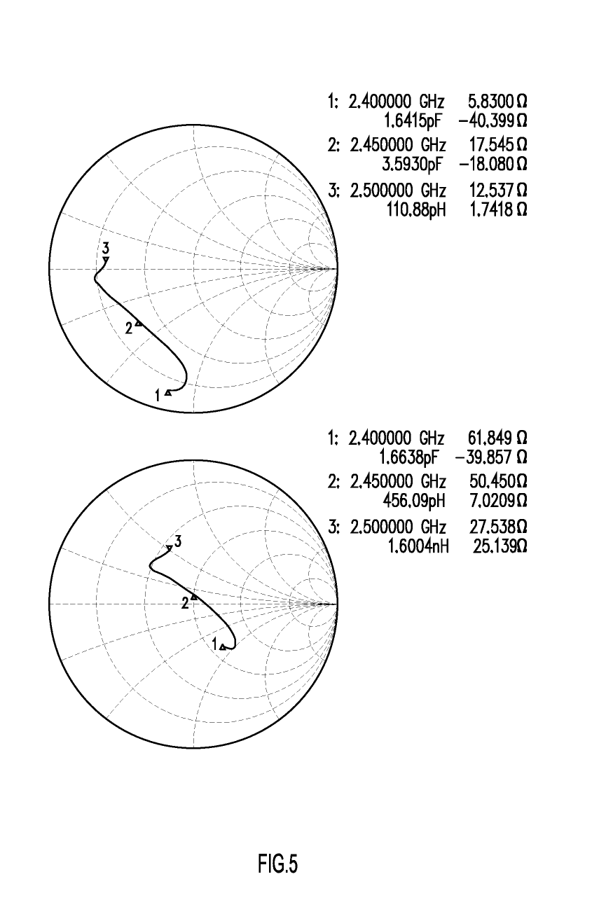

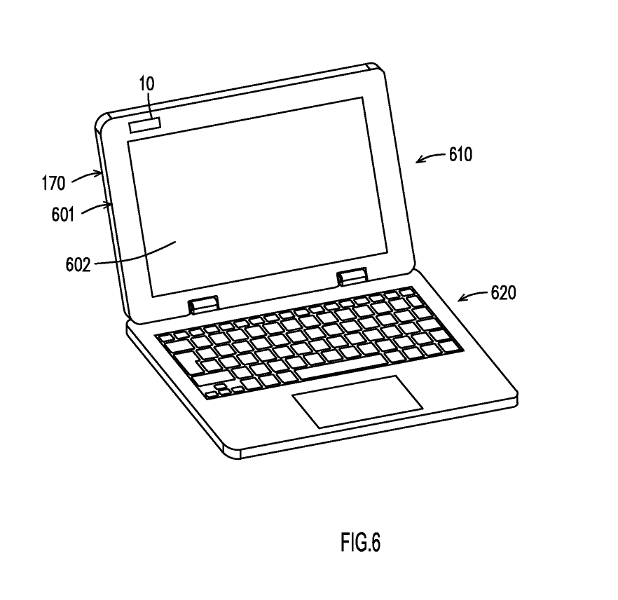

FIG. 4 is a graph depicting the frequency response (or reflection coefficient S11) of the embodiment of FIG. 3 according to the present invention. FIG. 5 shows Smith charts depicting the performance of the embodiment of FIG. 3 according to the present invention. In the embodiment of FIG. 3, the length and width of the substrate 110 are 30 mm and 8 mm, respectively. As shown in FIG. 4, the first frequency band and the second frequency band that are covered by the antenna 30 are 2.4 GHz and 5 GHz, respectively. In addition, the upper plot in FIG. 5 is a Smith chart of the antenna 30 without the second path 102 and the lower plot is a Smith chart of the antenna 30 including the second path 102. As shown in FIG. 5, the impedance of antenna element 30 at a frequency of 2.4 GHz on the Smith chart is close to the center (i.e., 50 ohms) after adding the second path 102. In other words, the radiation efficiency of the antenna 30 can be improve by including the second path 102.

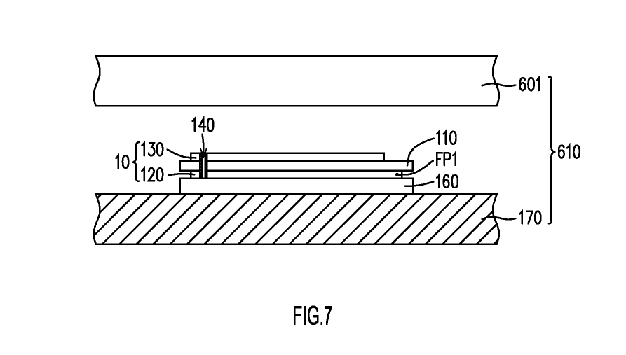

FIG. 6 is a perspective view of the electronic device according to an embodiment of the present invention. Reference is also made to FIG. 1A. As shown, the electric device 100 can be a notebook computer and the metal case 170 of the electric device 100 can be, for example, the metal back cover of the notebook computer. More specifically the electronic device 100 includes a plastic bezel 601, which surrounds display panel 602. The metal case 170 and the plastic bezel 601 overlap each other to form the first housing 610 of the electric device 100. The first housing 610 and a second housing 620 can be configured to rotate relative to each other via a hinge mechanism. As shown in FIG. 6, the antenna 10 (shown by broken lines) is disposed in the first housing 610. That is, the antenna 10 can be disposed in an electronic device having a full metal back cover.

FIG. 7 is a schematic view illustrating a sectional view of the embodiment of FIG. 1A according to an embodiment of the present invention. As shown in FIG. 7, the antenna 10 is disposed on the two surfaces (the first surface 111 and the second surface 112) of the substrate 110 in the first housing 610. The antenna 10 can be stacked on an inner side of the metal case 170 via the insulating/plastic element 160. In this embodiment, the distance between antenna 10 and metal case 170 can be on the order of 3 mm to enable the antenna 10 to easily fit inside a slim design of the electronic device 100.

In sum, a first radiation portion and a second radiation portion on opposing surfaces of a substrate can form an antenna for/in an electronic device. The second radiation portion includes a first ground point and a second ground point and the antenna can operate in a first frequency band via a first resonant path and can operate in a second frequency band via a second resonant path. In addition, impedance matching for the first frequency band can be adjusted via the second path and a radiation efficiency of the antenna can thus be improved. Such an antenna can be employed in an electronic device having a full metal back cover and slim design and still provide quality wireless communication performance.

The above description is intended by way of example only.

What is claimed is:

1. A mobile device, comprising:
a housing including a metal case; and
an antenna mounted inside the housing, the antenna comprising:
a first radiation portion disposed on a first surface of a substrate;
a second radiation portion disposed on an opposing surface of the substrate; and
a ground element,
wherein the second radiation portion includes a first grounding point and a second grounding point that are each electrically connected to the metal case via the ground element.

2. The mobile device of claim 1, further comprising an insulating element that is disposed between the substrate and the metal case.

3. The mobile device of claim 2, wherein the first surface of the substrate faces the insulating element.

4. The mobile device of claim 1, further comprising a conductive through hole that passes through the substrate and that electrically connects the first radiation portion and the second radiation portion.

5. The mobile device of claim 4, wherein the first radiation portion is a metal trace, the conductive through hole is disposed at a first end of the metal trace and a feedpoint for the antenna is disposed at a second end of the metal trace.

6. The mobile device of claim 1, wherein the first radiation portion comprises a single segment and the second radiation portion comprises a plurality of segments, and
wherein the single segment of the first radiation portion overlaps with at least one segment of the plurality of segments of the second radiation portion.

7. The mobile device of claim 1, wherein the first radiation portion comprises an L-shaped trace having a first shorter segment and a second longer segment, and the second radiation portion comprises a plurality of segments,
wherein a coupling gap is defined between the second longer segment of the L-shaped trace and at least one segment of the plurality of segments of the second radiation portion, and
wherein the coupling gap extends in a direction perpendicular to a thickness direction of the substrate.

8. The mobile device of claim 1, wherein a first resonant path extends between a feed point at one end of the first radiation portion and the first grounding point, and a second resonant path extends between the feed point at one end of the radiation portion and the second grounding point.

9. The mobile device of claim 8, wherein the first resonant path is configured to resonate at a first frequency band, and the second resonant path is configured to resonate at a second frequency band.

10. The mobile device of claims 8, wherein the first frequency band is centered at about 2.4 GHz and the second frequency band is centered at about 5 GHz.

11. An antenna comprising:
a first radiation portion disposed on a first surface of a substrate;
a second radiation portion disposed on an opposing surface of the substrate;
a conductive through hole through the substrate that electrically connects one end of the first radiation portion and the second radiation portion; and
a ground element,
wherein the second radiation portion includes a first grounding point and a second grounding point that are each electrically connected to the ground element.

12. The antenna of claim 1, further comprising an insulating element that is disposed adjacent the first surface of the substrate.

13. The antenna of claim 12, wherein the insulating element is plastic.

14. The antenna of claim 11, wherein the first radiation portion is a metal trace, the conductive through hole is disposed at a first end of the metal trace and a feedpoint for the antenna is disposed at a second end of the metal trace.

15. The antenna of claim 11, wherein the first radiation portion comprises a single segment and the second radiation portion comprises a plurality of segments, and
wherein the single segment of the first radiation portion overlaps with at least one segment of the plurality of segments of the second radiation portion.

16. The antenna of claim 1, wherein the first radiation portion comprises an L-shaped trace having a first shorter segment and a second longer segment, and the second radiation portion comprises a plurality of segments,
wherein a coupling gap is defined between the second longer segment of the L-shaped trace and at least one segment of the plurality of segments of the second radiation portion, and
wherein the coupling gap extends in a direction perpendicular to a thickness direction of the substrate.

17. The antenna of claim 1, wherein a first resonant path extends between a feed point at one end of the first radiation portion and the first grounding point, and a second resonant path extends between the feed point at one end of the radiation portion and the second grounding point.

18. The antenna of claim 1, wherein the first resonant path is configured to resonate at a first frequency band, and the second resonant path is configured to resonate at a second frequency band.

19. The antenna claims 1, wherein the first frequency band is centered at about 2.4 GHz and the second frequency band is centered at about 5 GHz.
